(19) United States
(12) Patent Application Publication
(10) Pub. No.: US 2024/0420401 A1
(43) Pub. Date: Dec. 19, 2024

(54) VIDEO DISPLAY DEVICE AND DISPLAY CONTROL METHOD FOR SAME

(71) Applicant: MAXELL, LTD., Kyoto (JP)

(72) Inventors: Mayumi NAKADE, Kyoto (JP); Osamu KAWAMAE, Kyoto (JP); Hitoshi AKIYAMA, Kyoto (JP); Tamotsu ITO, Kyoto (JP)

(21) Appl. No.: 18/819,687

(22) Filed: Aug. 29, 2024

Related U.S. Application Data
(63) Continuation of application No. 17/603,922, filed on Oct. 14, 2021.

(51) Int. Cl. G06T 13/20; G06T 13/40; G10H 1/40

(52) U.S. Cl. CPC G06T 13/205; G06T 13/40; G10H 1/40; G10H 2210/076

(57) ABSTRACT

A video display device for displaying a video of distributed content and an avatar, which is a computer-generated image, on a display screen to overlap each other, includes: a communication processing unit connected to a network; an avatar generation processing unit that generates an avatar of another person from avatar information received through the communication processing unit; a movement information detection processing unit that detects movement information of a continuous movement associated with the video of the content received through the communication processing unit; a display unit that displays the content received through the communication processing unit; and a control unit. The avatar generation processing unit generates an avatar by adding the movement information detected by the movement information detection processing unit to a movement of the generated avatar. The control unit displays the avatar generated by the avatar generation processing unit on the display unit to overlap the content.

### CROSS REFERENCE TO RELATED APPLICATION

This application is a Continuation of U.S. Application Ser. No. 17/603,922, filed Oct. 14, 2021, which is the U.S. National Phase under 35 U.S.C. § 371 of International Application No. PCT/JP2019/016512, filed on Apr. 17, 2019, the entire contents are hereby incorporated by reference.

### TECHNICAL FIELD

The present invention relates to a video display device and a display control method thereof.

### BACKGROUND ART

In recent years, various products have been put on the market for information terminals such as personal computers. Among these, in a head-mounted display device (hereinafter, referred to as an “HMD”) of a portable video display device, a distributed video and a computer-generated image (avatar) of augmented reality (AR) are displayed on a display screen in the form of glasses so as to overlap each other. For example, an application for a head-mounted display that allows a user to view the content, such as a concert or sports, in real time at the same time as other users and at the same time, can display the alter ego (avatar) of the user or the alter egos (avatars) of the other users on the display screen is already available.

Patent Document 1 is a relevant art in this technical field. Patent Document 1 describes a method of avoiding the influence of delay in remote communication in avatar display.

### CITATION LIST

### Patent Document

Patent Document 1: JP 2016-48855 A

### SUMMARY OF THE INVENTION

### Problems to be Solved by the Invention

For example, when enjoying a live video such as a concert with other users, the movements of avatars, which are alter egos of the other users, are important. In particular, in a live music or the like, the user feels very uncomfortable with the avatar who keeps moving with the rhythm that is out of sync with the music that the user is listening to.

On the other hand, in Patent Document 1, a sense of discomfort due to the delay of initial movement is reduced, but a sense of discomfort due to the deviation of continuous movement has not been taken into consideration.

It is an object of the present invention to provide a video display device and a display control method thereof for reducing a sense of discomfort when sharing a space with another person through an avatar.

### Solutions to Problems

To give an example in order to solve the aforementioned problem, the present invention is a video display device for displaying a video of distributed content and an avatar, which is a computer-generated image, on a display screen so as to overlap each other. The video display device includes: a communication processing unit connected to a network; an avatar generation processing unit that generates an avatar of another person from avatar received through the information communication processing unit; a movement information detection processing unit that detects movement information of a continuous movement associated with the video of the content received through the communication processing unit; a display unit that displays the content received through the communication processing unit; and a control unit. The avatar generation processing unit generates an avatar by adding the movement information detected by the movement information detection processing unit to a movement of the generated avatar, and the control unit displays the avatar generated by the avatar generation processing unit on the display unit so as to overlap the content.

### Effects of the Invention

According to the present invention, it is possible to provide a video display device and a display control method thereof for reducing a sense of discomfort when sharing a space through an avatar.

### BRIEF DESCRIPTION OF THE DRAWINGS

FIG. 1 is a schematic configuration diagram of a video display system in a first embodiment.

FIG. 2 is a schematic diagram of live concert watching in the first embodiment.

FIG. 3 is a hardware configuration diagram of an HMD in the first embodiment.

FIG. 4 is a functional block configuration diagram of the HMD in the first embodiment.

FIG. 5 is an entire process flowchart of the HMD in the first embodiment.

FIG. 6 is a flowchart of preparation processing of the HMD in the first embodiment.

FIG. 7 is a flowchart of live content processing of the HMD in the first embodiment.

FIG. 8 is a flowchart of avatar display processing of the HMD in the first embodiment.

FIG. 9 is a flowchart for determining whether or not to display an avatar in the HMD in the first embodiment.

FIG. 10 is a functional block configuration diagram of an HMD in a second embodiment.

FIG. 11 is a flowchart of avatar display processing in a third embodiment.

FIG. 12 is a flowchart showing a processing procedure of a management server in a fourth embodiment.

FIG. 13 is a schematic configuration diagram of a video display system in a fifth embodiment.

FIG. 14 is an external view of a smartphone in a sixth embodiment.

FIG. 15 is a flowchart of self-movement reflection processing in a seventh embodiment.

FIG. 16 is a library table according to an eighth embodiment.

### MODE FOR CARRYING OUT THE INVENTION

Hereinafter, embodiments of the present invention will be described with reference to the diagrams.

### First Embodiment

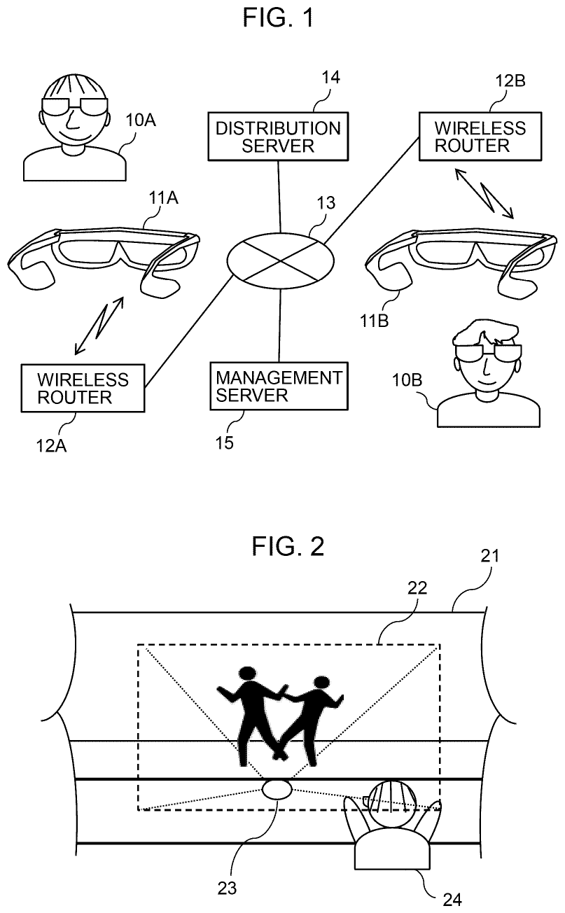

FIG. 1 is a schematic configuration diagram of a video display system in the present embodiment. In addition, the present invention is applied when there are a plurality of users. However, for the sake of simplicity, in the present embodiment, as shown in FIG. 1, the description will be limited to two users (a first user 10A and a second user 10B).

In FIG. 1, the first user 10A wearing an HMD 11A, which is a video display device, and the second user 10B wearing an HMD 11B are connected to a network 13 through a wireless router 12A and a wireless router 12B, respectively. A distribution server 14 and a management server 15 are connected to the network 13.

The distribution server 14 distributes the live content live on the network 13 by live streaming. The live content based on live streaming, which is distributed from the distribution server 14, is distributed to the HMD 11A through the network 13 and the wireless router 12A and distributed to the HMD 11B through the network 13 and the wireless router 12B. As for the distributed live content, the video is displayed on the display screen of the HMD, and the audio is output from the speaker of the HMD.

The management server 15 manages a plurality of pieces of information acquired through the network 13. Examples of the information managed by the management server 15 include content information, information regarding a user, movement information (movement information of the first user 10A) or audio information of the HMD 11A acquired through the wireless router 12A, and movement information (movement information of the second user 10B) or audio information of the HMD 11B acquired through the wireless router 12B.

The content information includes live title information, artist information such as a performer or a singer, time information such as start time and end time of live content, and music score information such as beat or tempo of music.

The information regarding a user includes user information (user identification information) such as a nickname including a name or a handle name, user-specific avatar information, management information for managing a plurality of users who simultaneously watch the live content, and the like.

The movement information includes movements, such as clapping hands, waving the neck or hands, raising and lowering hands, standing, sitting, stepping, and jumping, as vector information for moving each joint of the avatar.

With such a system configuration, while watching the live content, an avatar, which is a computer-generated image that is the alter ego of another person different from the user watching the live content, can be displayed so as to overlap the live content by adding the movement information of another person. Therefore, it is possible to share a fun situation with friends through an avatar.

FIG. 2 is a schematic diagram for explaining a state in which the first user 10A is watching a live concert. In FIG. 2, the distribution server 14 distributes a video 21 of the entire live concert performed by the artist.

The video 21 of the entire live concert can be realized, for example, by combining videos captured by a plurality of cameras or by taking a picture with a 360° camera.

By distributing the video 21 of the entire live concert, the video of the live concert corresponding to the change in a direction in which the HMD 11A worn by the first user 10A faces can be displayed on the display screen of the HMD 11A. For example, when the direction of the HMD 11A is changed to the rear direction, a video of the audience seat is displayed.

On a display screen 22 of the HMD 11A worn by the first user 10A, a video cut out from the distributed video 21 of the entire live venue according to the direction in which the HMD 11A faces is displayed. In addition, for the watching position, a state of watching at the center position 23 of the live venue, which is considered to be the best watching position at the center of the video 21 of the entire live venue, is assumed. Undoubtedly, on the display screen of the HMD 11B worn by the second user 10B, a state of watching at the center position 23 of the live venue, which is considered to be the best watching position at the center of the video 21 of the entire live venue, is assumed.

An avatar 24, which is the alter ego of the second user 10B displayed in the present embodiment, uses user-specific avatar information of the second user 10B stored in the management server 15.

The display position of the avatar 24, which is the alter ego of the second user 10B, may be arbitrary. In the present embodiment, however, the relative positions of the first user 10A and the second user 10B are maintained. For example, a state in which the second user 10B is present to the right of the first user 10A and the first user 10A is present to the left of the second user 10B means that the first user 10A and the second user 10B recognize each other. In the schematic diagram of FIG. 2 in the present embodiment, the avatar 24, which is the alter ego of the second user 10B, is set to be present on the right side of the watching position of the first user 10A. In addition, similarly, when a third user is present, the relative positions of the three users are maintained.

In addition, any general avatar can be placed in other audience seats including the back, but various avatars acquired from an external server can also be placed through a network or the like.

The HMD 11A detects the rhythm of the music played in the live concert, and moves the avatar 24, which is the alter ego of the second user 10B, in synchronization with the rhythm. In addition, the movement information of the second user 10B acquired from the management server 15 is reflected in the avatar 24 that is the alter ego of the second user 10B.

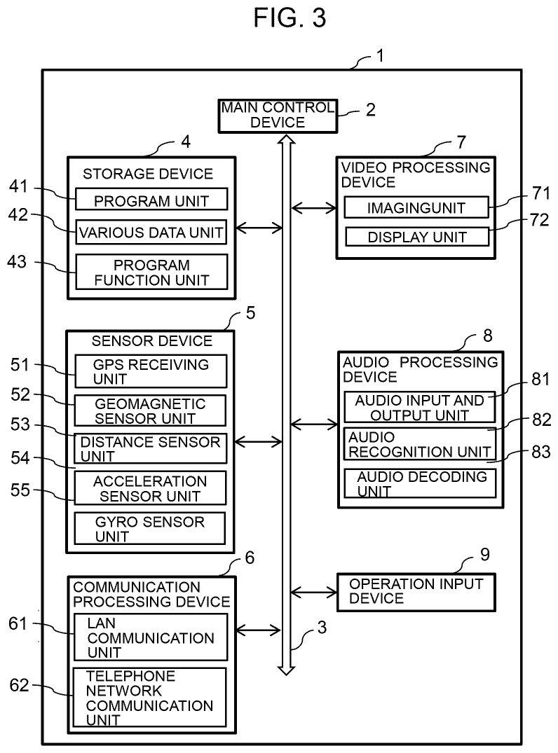

Next, an HMD, which is a head-mounted video display device in the present embodiment, will be described with reference to the diagrams. FIG. 3 is a hardware configuration diagram showing an example of the internal configuration of the HMD in the present embodiment. In FIG. 3, an HMD 1 is configured to include a main control device 2, a system bus 3, a storage device 4, a sensor device 5, a communication processing device 6, a video processing device 7, an audio processing device 8, and an operation input device 9.

The main control device 2 is a microprocessor unit that performs overall control of the HMD 1 according to a predetermined operation program. The system bus 3 is a data communication path for transmitting and receiving various commands or data between the main control device 2 and each constituent block in the HMD 1.

The storage device 4 is configured to include a program unit 41 that stores a program for controlling the movement of the HMD 1, a various data unit 42 that store various kinds of data such as movement setting values, detection values from a sensor unit described later, and objects including contents, and a rewritable program function unit 43 such as a work area used for various program operations. In addition, the storage device 4 can store an operation program downloaded through the network, various kinds of data created by the operation program, and the like. In addition, contents such as moving images, still images, or sounds downloaded through the network can be stored. In addition, data such as a moving image or a still image captured using the camera function can be stored. In addition, the storage device 4 needs to hold information stored even when no power is supplied from the outside to the HMD 1. Therefore, for example, devices, such as a semiconductor device memory such as a flash ROM or an SSD (Solid State Drive) and a magnetic disk drive such as an HDD (Hard Disc Drive), are used. In addition, each operation program stored in the storage device 4 can be updated and its function can be extended by processing of downloading from each server device on the network.

The sensor device 5 is a sensor group of various sensors for detecting the state of the HMD 1. The sensor device 5 is configured to include a GPS (Global Positioning System) receiving unit 51, a geomagnetic sensor unit 52, a distance sensor unit 53, an acceleration sensor unit 54, and a gyro sensor unit 55. Due to the sensor group, it is possible to detect the position, inclination, direction, movement, and the like of the HMD 1. In addition, the HMD 1 may further include other sensors, such as an illuminance sensor and a proximity sensor. In addition, if a device paired with these sensors is attached to the hand or arm, the movement of the hand or arm can be detected. By comprehensively utilizing the sensor group, it is possible to detect movements, such as clapping hands, waving the neck or hands, raising and lowering hands, standing, sitting, stepping, and jumping.

The communication processing device 6 is configured to include a LAN (Local Area Network) communication unit 61 and a telephone network communication unit 62. The LAN communication unit 61 is connected to a network, such as the Internet, through an access point or the like, and transmits and receives data to and from various server devices on the network. Connection with an access point or the like may be performed by wireless connection, such as Wi-Fi (registered trademark). The telephone network communication unit 62 performs telephone communication (call) and data transmission and reception by wireless communication with a base station of a mobile phone communication network. The communication with the base station or the like may be performed by a W-CDMA (Wideband Code Division Multiple Access) (registered trademark) method, a GSM (Global System for Mobile communications) (registered trademark) method, an LTE (Long Term Evolution) method, or other communication methods. Each of the LAN communication unit 61 and the telephone network communication unit 62 includes an encoding circuit, a decoding circuit, an antenna, and the like. In addition, the communication processing device 6 may further include other communication units such as a Bluetooth (registered trademark) communication unit and an infrared communication unit.

The video processing device 7 includes an imaging unit 71 and a display unit 72. The imaging unit 71 is a camera unit that inputs image data of the surroundings or an object by converting the light input from the lens into an electrical signal using an electronic device, such as a CCD (Charge Coupled Device) or CMOS (Complementary Metal Oxide Semiconductor) sensor. The display unit 72 is a display device, such as a liquid crystal panel, and provides image data to the user of the HMD 1. The display unit 72 includes a video RAM (not shown). Then, displaying on the display screen is performed based on the image data input to the video RAM.

The audio processing device 8 is configured to include an audio input and output unit 81, an audio recognition unit 82, and an audio decoding unit 83. The audio input unit of the audio input and output unit 81 is a microphone, and the user's voice or the like is converted into audio data to be input. In addition, the audio output unit of the audio input and output unit 81 is a speaker, and audio information and the like necessary for the user are output. The audio recognition unit 82 analyzes the input audio information and extracts an instruction command and the like. The audio decoding unit 83 has a function of performing decoding processing g (sound synthesis processing) on the encoded audio signal and the like when necessary.

The operation input device 9 is an instruction input unit for inputting an operation instruction to the HMD 1. The operation input device 9 is configured to include operation keys in which button switches and the like are arranged. Other operation devices may be further provided. In addition, the communication processing device 6 may be used to operate the HMD 1 by using a separate mobile terminal device connected by wired communication or wireless communication. In addition, the audio recognition unit 82 of the audio processing device 8 may be used to operate the HMD 1 by an audio command of an operation instruction.

In addition, in the configuration example of the HMD 1 shown in FIG. 3, many components that are not essential in the present embodiment are provided, but the effect of the present embodiment is not affected even with a configuration in which these are not provided. In addition, components (not shown) such as a digital broadcast receiving function or an electronic money payment function may be further added.

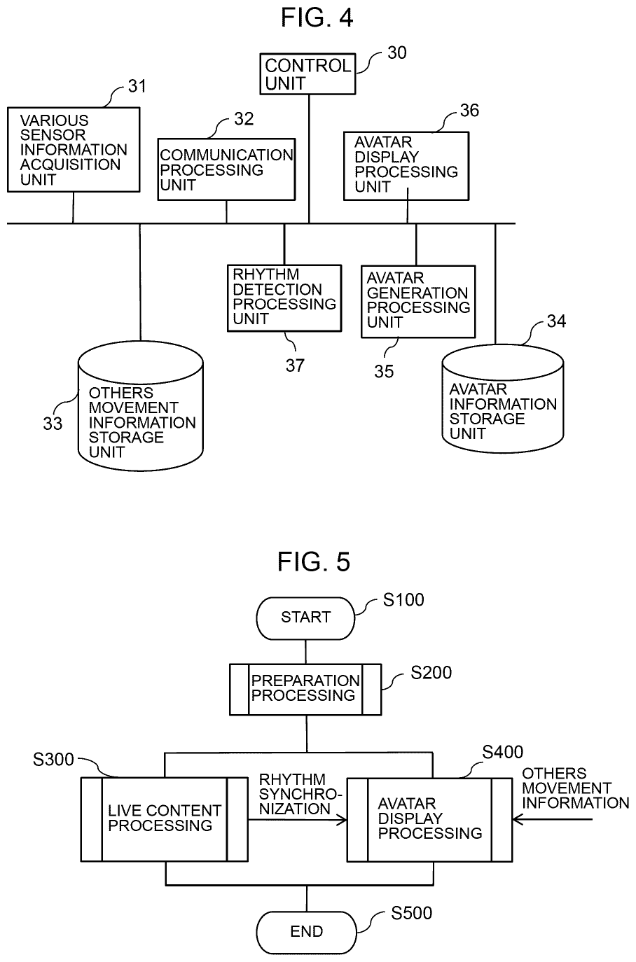

FIG. 4 is a functional block configuration diagram of the HMD 1 in the present embodiment. In FIG. 4, a control unit 30 is mainly executed by the main control device 2 and the program unit 41 and the program function unit 43 of the storage device 4 in FIG. 3.

A various sensor information acquisition unit 31 is a function of acquiring information from various sensors of the sensor device 5, and is a function of grasping its own operating state.

A communication processing unit 32 is mainly executed by the LAN communication unit 61 of the communication processing device 6 in FIG. 3, and is a function of uploading various kinds of information of the HMD 1 to the management server 15 or downloads various kinds of information from the management server 15. In addition, the communication processing unit 32 is a function of downloading the live content from the distribution server 14.

An others movement information storage unit 33 is a function of acquiring the movement information and audio information of another user different from the user watching the HMD 1, which are acquired by the management server 15, from the communication processing unit 32, and storing the movement information and the audio information in the various data unit 42 of the storage device 4.

An avatar information storage unit 34 is a function of acquiring other user-specific avatar information managed by the management server 15 from the communication processing unit 32 and storing the other user-specific avatar information in the various data unit 42 of the storage device 4.

An avatar generation processing unit 35 is mainly executed by the main control device 2 in FIG. 3, and is a function of generating an avatar by adding the others movement information stored in the others movement information storage unit 33 to the avatar stored in the avatar information storage unit 34.

An avatar display processing unit 36 is executed by the display unit 72 of the video processing device 7 in FIG. 3, and is a function of displaying the avatar generated by the avatar generation processing unit 35. However, as will be described later, the avatar may deviate from the display screen of the HMD 1 depending on the position or direction of the HMD 1. Therefore, it is necessary to determine whether or not the avatar can be displayed.

A rhythm detection processing unit 37 is mainly executed by the main control device 2 and the audio processing device 8 in FIG. 3, and is a function of detecting the rhythm (beat) of the music in the live content. If there is content information (music score information) managed by the management server 15, the communication processing unit 32 acquires the content information from the management server 15 and uses the content information as rhythm (beat) information. When the music to be played is known from the program guide or the like, it is also possible to acquire music score information, such as rhythm or tempo relevant to the music, through the Internet or the like.

When the music score information cannot be acquired from the management server 15 or the Internet or the like, the rhythm (beat) is detected by the repeating pattern of sound intensity while reproducing the live content from the distribution server 14.

Next, FIG. 5 shows an entire process flowchart in the HMD 1 in the present embodiment executed by the control unit 30. In FIG. 5, in the process in the HMD 1, preparation processing S200 is performed after the start (S100). The preparation processing S200 is processing performed before receiving the live content, and the setting of users watching the live content together is performed.

After the end of the preparation processing S200, the start of the live content is awaited. Then, at the same time as the live content receiving operation (live content processing S300), avatar display processing S400 is performed.

In the live content processing S300, the transmitted content is displayed and information regarding the rhythm synchronization is transmitted for the avatar display processing S400, so that rhythmic movement information synchronized with the rhythm is generated and the avatar performs an operation according to the rhythm.

In the avatar display processing S400, when there is a movement of another person, the movement is input as others movement information for the avatar display processing S400 and is reflected in the avatar display.

When the live content ends, the live content processing S300 and the avatar display processing S400 end, and the entire process ends (S500).

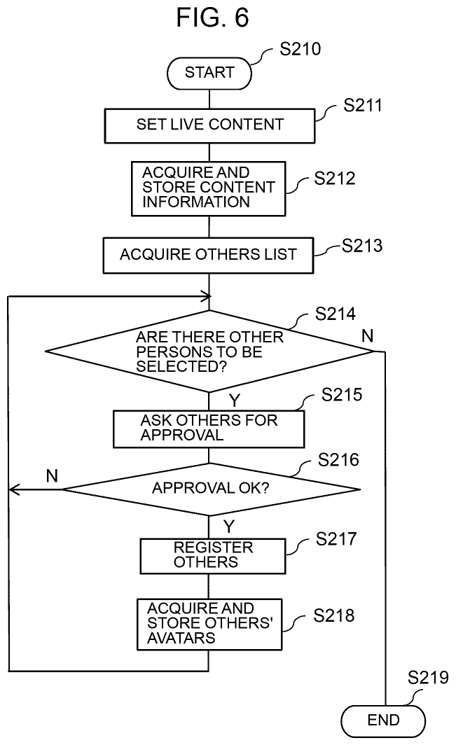

FIG. 6 is a flowchart of the preparation processing S200 in the entire process flowchart of FIG. 5. In FIG. 6, when the preparation processing S200 is started (S210), first, the live content is searched for and set (S211). The live content is selected and set from the live content already managed by the management server 15 or the program guide provided by the distribution server 14.

Then, in step S212, the set live content information is acquired from another server or the like through the management server 15, the distribution server 14, or the network 13, and is stored in the various data unit 42 of the storage device 4. The acquired live content information can be effectively used even in the case of watching alone. Then, in step S213, a user list (others list) registered in the management server 15 is acquired from the management server 15.

Then, in step S214, it is determined whether or not there is a user with whom watching the set live content is desired in the acquired user list (others list). If there is a user with whom watching the set live content is desired in S214, the set live content is disclosed to the user (another person) with whom watching the set live content is desired, and an approval request is made as to whether or not to watch the set live content together (S215).

Then, in step S216, it is determined whether or not approval has been obtained from the user (another person) with whom watching the set live content is desired. If no approval is obtained from the user (another person) with whom watching the set live content is desired in S216, the process returns to S214 to search for another user to be selected.

If approval is obtained from the user (another person) with whom watching the set live content is desired in the processing of S216, the user (another person) with whom watching the set live content is desired is registered in the management server 15 as a user with whom watching the set live content is desired (S217). Then, in step S218, unique avatar data (friend avatar) of the user with whom watching the set live content is desired is acquired from the management server 15 and stored in the various data unit 42 of the storage device 4, and the process returns to S214.

If there is no user with whom watching the set live content is desired in the acquired user list in S214, the preparation processing S200 ends (S219).

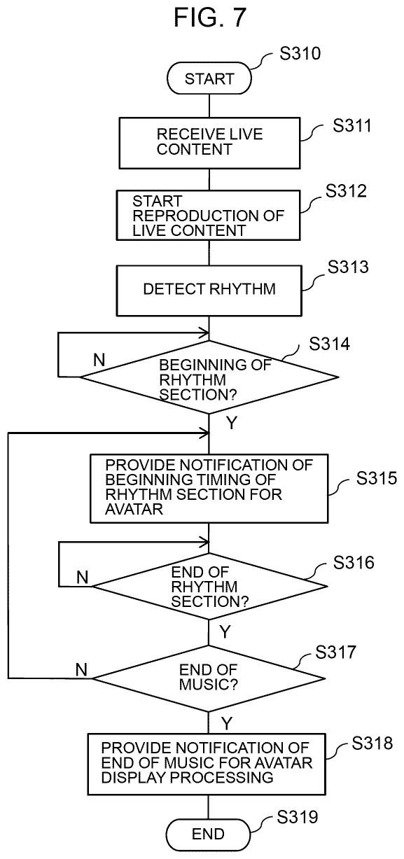

FIG. 7 is a flowchart of the live content processing S300 in the entire process flowchart of FIG. 5. In FIG. 7, when the live content processing S300 is started (S310), the start of the live content is awaited to receive the live content (S311). Then, the received live content is reproduced (S312).

Then, in step S313, the rhythm of the live content is detected while reproducing the live content. In addition, if the content information of the management server 15 includes the music score data, the beat and tempo (beat length) can be known, so that no particular rhythm detection processing is performed.

Rhythm detection is usually recognized by repeating a pattern (rhythm section) including one strong beat and one or more weak beats. Therefore, at least two rhythm sections are required to recognize the rhythm. As a specific example of rhythm detection, for example, sound data is divided into appropriate frame lengths, the amount of volume within a frame is calculated, and the amount of volume increase between frames is calculated. Then, the rhythm is detected by frequency-analyzing the amount of volume increase to convert the peak frequency into bpm (Beats Per Minute).

Then, in step S314, it is determined whether or not the music of the live content has reached the beginning of the rhythm section. Then, the processing of S314 is repeated until the music of the live content reaches the beginning of the rhythm section.

Then, in step S315, when the music of the live content reaches the beginning of the rhythm section, notification of the beginning timing of the rhythm section is provided for the avatar display processing.

Then, in step S316, it is determined whether or not the music of the live content has reached the end of the rhythm section. Then, the processing of S316 is repeated until the music of the live content reaches the end of the rhythm section.

Then, in step S317, when the music of the live content reaches the end of the rhythm section, it is determined whether or not the music of the live content has ended. If the music of the live content has not ended in S317, the end of the rhythm section is the same timing as the beginning of the next rhythm section. Therefore, the process returns to S315.

If the music of the live content had ended in the processing of S317, notification that the music of the live content has ended is provided for the avatar display processing (S318), and the live content processing S300 ends (S319).

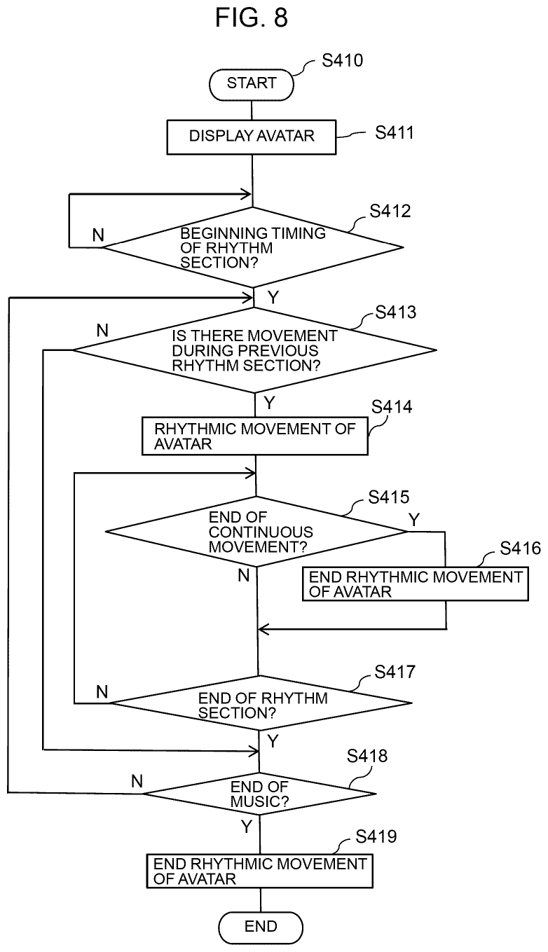

FIG. 8 is a flowchart of the avatar display processing S400 in the entire process flowchart of FIG. 5. In FIG. 8, when the avatar display processing S400 is started (S410), first, unique avatar data (friend avatar) of the selected user watching the live content together is acquired from the management server 15 and displayed at a predetermined position (S411).

The friend avatar is a unique avatar of the selected user, and is an avatar having an image reminiscent of the selected user, such as a height or body shape. The friend avatar is a user-specific avatar registered in the management server 15 by the user (or another person other than the user). Undoubtedly, it is needless to say that a general-purpose avatar without general features can be used without using the unique avatar data of the selected user. The friend avatar is moved by acquiring, for example, a stationary state, such as a sitting state or a standing state, or movement information from the information of various sensors of the selected user's HMD and generating the movement information.

Then, in step S412, it is determined whether or not the timing is the beginning of the rhythm section. Specifically, the beginning timing of the rhythm section from the processing of S315 in the live content processing S300 is awaited. The processing of S412 is repeated until the beginning timing of the rhythm section is reached.

Then, in step S413, it is determined whether or not there is continuous movement information and audio information of the selected user watching the live content together from the management server 15 during the previous rhythm section (rhythm section immediately before). Then, if there is no continuous movement information and audio information, the process proceeds to S418 described later. In addition, if there is continuous movement information, the rhythmic movement information is added to the movement of the avatar in step S414. In addition, if there is audio information, the output of the audio information is started, and the audio output is continued until there is no audio information.

Then, in step S415, the end of the display of the moving avatar is determined based on the presence or absence of continuous movement information. The processing of S414 is repeated until the display of the moving avatar ends. Then, if the display of the moving avatar had ended in the processing of S415, the rhythmic movement of the friend avatar is stopped (S416).

Then, it is determined whether or not the rhythm section has reached the end (S417). If the rhythm section has not reached the end, the process returns to S415. If the rhythm section reaches the end in the processing of S417, it is determined whether or not the music has ended (S418). Specifically, it is determined whether or not there is a music end notification from the processing of S318 in the live content processing S300.

If the music has not ended in the processing of S418, the end of the rhythm section is the same timing as the beginning of the next rhythm section. Therefore, the process returns to S413. If the music has ended in the processing of S418, the rhythmic movement processing of the avatar ends (S419).

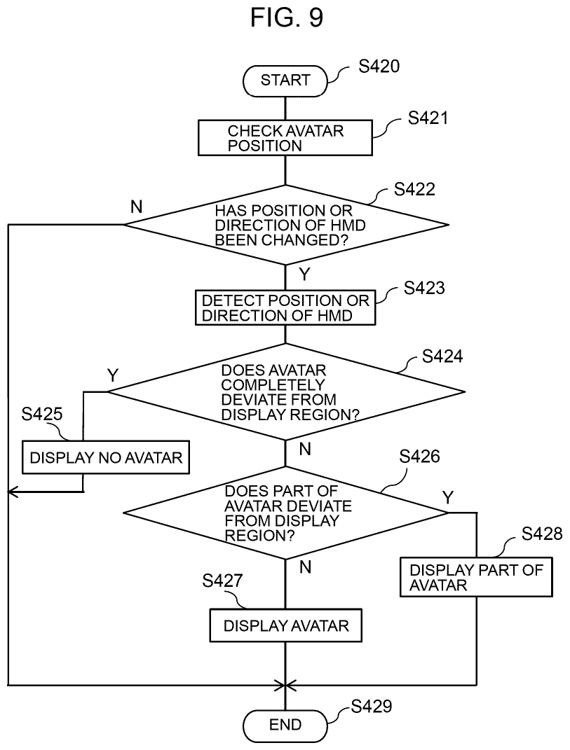

Here, FIG. 9 shows a detailed flowchart of the avatar display processing S411 in FIG. 8. FIG. 9 is a process of determining whether or not the avatar is within the display range and controlling the display.

In FIG. 9, when the process is started (S420), the position of the avatar to be displayed is checked (S421). Then, it is determined whether or not the position or direction of the HMD 1 is the same as the previous position or direction of the HMD 1 (S422).

If it is determined that the position or direction of the HMD 1 has been changed in the processing of S422, the position or direction of the HMD 1 after the change is detected (S423). Initially, since there is no information regarding the previous position or direction of the HMD 1, it is determined that the position or direction of the HMD 1 has been changed.

Then, it is determined whether or not the avatar completely deviates from the position of the avatar determined in the processing of S421 on the display screen of the HMD 1 at the changed position or direction of the HMD 1 (S424). If the avatar completely deviates in the processing of S424, the avatar is not displayed (S425). Thereafter, the avatar display availability routine ends (S429).

If the avatar does not completely deviate in the processing of S424, it is determined whether or not a part of the avatar deviates (S426). If the avatar does not deviate at all in S426, the complete avatar is displayed (S427). Thereafter, the avatar display availability routine ends (S429).

If the avatar partially deviates in the processing of S426, the remaining avatar that does not deviate is displayed on the display screen of the HMD 1 (S428). Thereafter, the avatar display availability routine ends (S429).

In such a procedure, it is determined whether or not the avatar can be displayed. It is desirable to determine whether or not the avatar can be displayed each time the avatar is displayed.

As described above, in the present embodiment, the rhythm of the music to be listened to is detected, and the movement of the avatar, which is the alter ego of another user that is displayed, is displayed as a movement synchronized with the detected rhythm. Therefore, since the movement of the avatar, which is the alter ego of another user, is a movement synchronized with the rhythm, it is possible to bring about a realistic viewing effect in a live music or the like.

In addition, although the rhythm of the music has been described in the present embodiment, the rhythm of the music is not limited to this, and may be a continuous movement including movements such as cheering and shouting, which are reactions to watching sports and watching the stage, and movements such as ensemble and chorus performed together with the video. In this case, the rhythm detection processing unit 37 may be replaced with a movement information detection processing unit. In this manner, according to the present embodiment, by displaying the avatar in a movement synchronized with a continuous movement, it is possible to reduce a sense of discomfort through the avatar when sharing the space.

### Second Embodiment

In the first embodiment, the avatars of other users watching the live content together are displayed, but the avatar of the host user watching the live content is not displayed. In the present embodiment, an example will be described in which not only are the avatars of other users watching the live content together displayed, but also the avatar of the host user watching the live content is displayed.

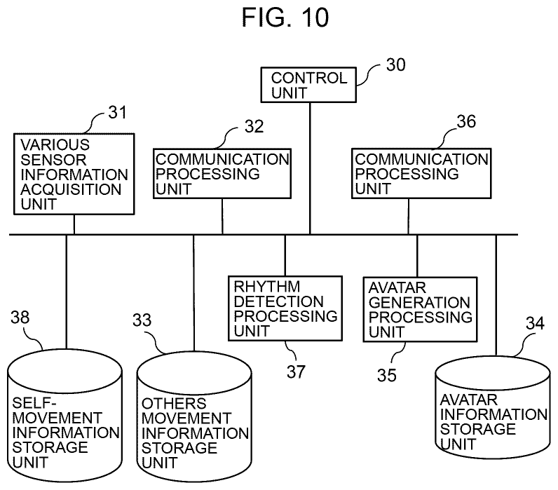

FIG. 10 is a functional block diagram of the HMD 1 in the present embodiment. In FIG. 10, the same functions as in FIG. 4 are denoted by the same reference numerals, and the description thereof will be omitted. The configuration of FIG. 10 is different from that of FIG. 4 in that a self-movement information storage unit 38 is added.

In FIG. 10, the various sensor information acquisition unit 31 acquires information from various sensors of the sensor device 5 and grasps the movement state of the host user.

As for the movement information regarding the rhythm of the host user, movement information regarding the rhythm of the host user acquired by the various sensor information acquisition unit 31 is stored in the various data unit 42 of the storage device 4 by the self-movement information storage unit 38.

The avatar information, which is the alter ego of the host user, has been created by the host user himself or herself in advance, and is stored in the various data unit 42 of the storage device 4 by the avatar information storage unit 34. Undoubtedly, it is needless to say that the avatar information of the host user is already registered in the management server 15.

The avatar of the host user is generated by the avatar generation processing unit 35 by adding the movement information of the host user from the self-movement information storage unit 38 to the avatar of the host user stored in the avatar information storage unit 34, and the avatar of the host user is displayed by the avatar display processing unit 36.

In this manner, the avatar of the host user can be displayed at the center position 23 of the live venue, which is considered to be the best watching position at the center of the video 21 of the entire live venue in the schematic diagram of the live concert watching of FIG. 2.

### Third Embodiment

In the first embodiment, when there is continuous movement information of the user watching the live content together from the management server 15 during the previous rhythm section (rhythm section immediately before), the avatar is made to perform rhythmic movement. On the other hand, in the present embodiment, a case will be described in which the movement information is quickly reflected in the avatar when the movement information of the user watching the live content together during the rhythmic movement is acquired.

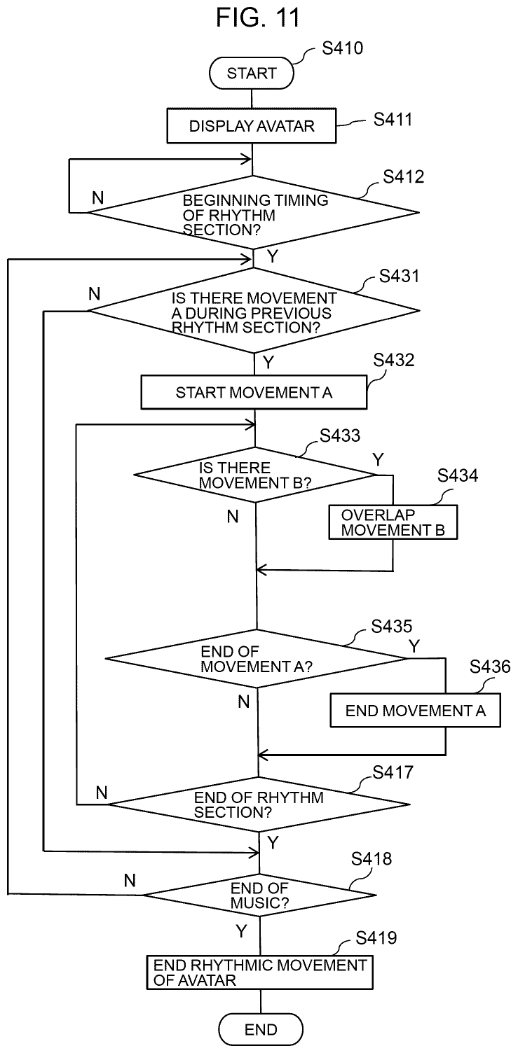

FIG. 11 is a flowchart of the avatar display processing in the present embodiment. In FIG. 11, the same functions as in FIG. 8 are denoted by the same reference numerals, and the description thereof will be omitted. The configuration of FIG. 11 is different from that of FIG. 8 in that the processing of S413 to S416 in FIG. 8 is changed to the processing of S431 to S436.

In the present embodiment, it is assumed that, when the user watching the live content together gets a sense of the rhythm, the user can move according to the rhythm. Normally, the movement relevant to the rhythm is started at the beginning timing (strong beat) of the rhythm section. The movement relevant to the rhythm that is performed at the beginning of each rhythm section is the same in many cases. In the present embodiment, the same rhythmic movement is defined as a movement A. In addition, when a movement relevant to a rhythm different from the movement A is performed at the beginning timing (strong beat) of the rhythm section, this is defined as a movement B meaning a movement different from the movement A. For example, assuming that the movement A is a continuous shaking movement, the movement B is a movement larger than the movement A, a large movement or jump, or a movement such as a large hand raising.

In FIG. 11, first, it is determined whether or not there is movement information A of the user watching the live content together from the management server 15 during the previous rhythm section (rhythm section immediately before) (S431). This processing is equivalent to the processing of S413 in FIG. 8.

In the processing of S431, if there is no movement information of the user watching the live content together from the management server 15 during the previous rhythm section, the process proceeds to S418 described later.

In the processing of S431, if there is the movement information A of the user watching the live content together from the management server 15 during the previous rhythm section, the friend avatar starts to move in consideration of the movement information A (S432).

Then, it is determined whether or not there is movement information B of the user watching the live content together (S433). If there is the movement information B of the user in the processing of S433, the movement of the avatar becomes a movement in which the movement B overlaps the movement A (S434). If there is no movement information B of the user in the processing of S433, it is determined whether or not the movement A has ended (S435).

If the movement A has not ended in the processing of S435, the end of the rhythm section is determined (S417). If this is not the end of the rhythm section in the processing of S417, the process returns to S433. If the movement A has ended in the processing of S435, the end of the rhythm section is determined, and in the case of the end, the end of the music is determined in the same manner as in FIG. 8 (S418).

As described above, according to the present embodiment, when the user performs another movement while performing the rhythmic movement, the movement information can be quickly and smoothly reflected on the avatar display. In addition, when there is only the movement B without the movement A, the movement information of movement B may be reflected on the avatar display.

### Fourth Embodiment

In the first to third embodiments, the live distribution of a concert or the like is assumed. On the other hand, in the present embodiment, an example of being applied to video distribution once converted into video instead of live distribution will be described.

In the video distribution, content reproduction can be started arbitrarily. However, the video distribution is not suitable for watching and enjoying with other users. In the present embodiment, a method is provided in which even the video-distributed content can be watched and enjoyed together with other users. Therefore, in the present embodiment, a function is added in which the video-distributed content information is once received by the management server 15 and then simultaneously video-distributed from the management server 15 again. The management server 15 can receive the entire video-distributed content and then perform the video distribution again. In the present embodiment, however, the content video-distributed from the distribution server 14 is time-shifted by the management server 15 and video-distributed again by the management server 15.

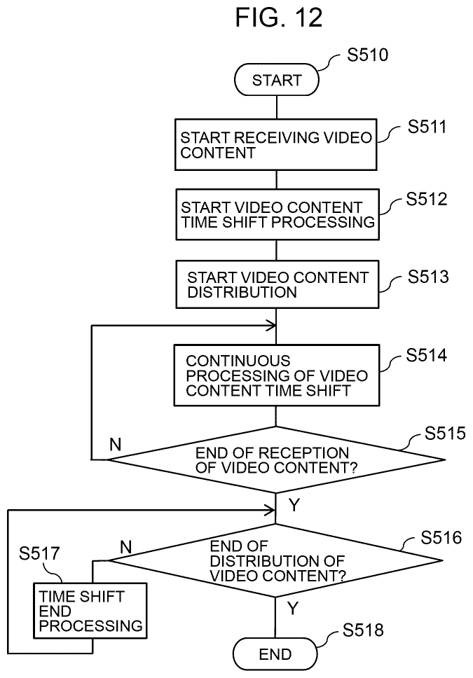

FIG. 12 is a flowchart showing a processing procedure of the management server 15 in the present embodiment. In FIG. 12, when video content support processing (S510) is started, the management server 15 starts receiving the video content designated by the user from the distribution server 14 (S511), and stores the video content in the various data unit 42 of the storage device 4.

Then, in step S512, time shift processing is started for the video content to be stored. The time shift processing is processing in which received data is temporarily stored and transmitted and the transmitted data is overwritten and received.

Then, in step S513, simultaneous distribution of the received video content is started for all the users watching the video content together, who are registered in the management server 15. During the time, continuous processing (distributing while receiving) of the time shift for the video content is performed (S514).

Then, in step S515, it is determined whether or not the reception of the video content from the distribution server 14 has ended. If the reception of the video content has not ended, the process returns to S514 to continue the time shift processing. If the reception of the video content has ended, it is determined whether or not the distribution of the video content has ended (S516).

If the distribution of the video content has not ended in the processing of S516, time shift end processing is performed (S517). Specifically, since the reception of the video content has ended, the remaining video content that has not yet been distributed is distributed.

If the distribution of the video content has ended in the processing of S516, the video content support processing of the management server 15 ends (S518).

By this time shift processing, the storage medium used temporarily is used while being overwritten, so that the storage capacity used can be reduced.

As described above, according to the present embodiment, even the content by video distribution can be realized by video-distributing the video-distributed content information simultaneously to the users watching the content together by using the function added to the management server 15.

### Fifth Embodiment

In the first to third embodiments, it is assumed that the video live-distributed through the network or the like is displayed on the display screen of the HMD. On the other hand, in the present embodiment, an example of being applied to the display of live video by a general TV receiver will be described.

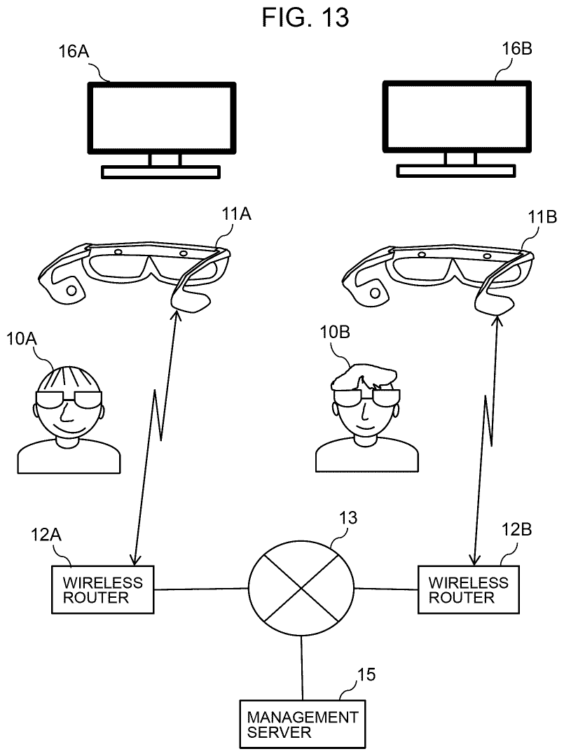

FIG. 13 is a schematic configuration diagram of a video display system in the present embodiment. In FIG. 13, the same functions as in FIG. 1 are denoted by the same reference numerals, and the description thereof will be omitted. The configuration of FIG. 13 is different from that of FIG. 1 in that the transmissive HMDs 11A and 11B are adopted and TV receivers 16A and 16B, instead of the distribution server 14, are components.

That is, the first user 10A watches the display screen of the TV receiver 16A through the transmissive HMD 11A and the movement information of the first user 10A is transmitted to the management server 15 through the wireless router 12A and the network 13. Similarly, the second user 10B watches the display screen of the TV receiver 16B through the transmissive HMD 11B, and the movement information of the second user 10B is transmitted to the management server 15 through the wireless router 12B and the network 13. The transmitted movement information is reflected as the movement of the avatar on the display screens of the HMDs 11A and 11B through the network 13 and the wireless routers 12A and 12B from the management server 15.

In this manner, even in a live video by a general TV receiver, the present invention can be applied by acquiring the movement information of the user watching the live video together from the management server 15 and reflecting the movement information on the avatar of the user watching the live video together.

In addition, this transmissive HMD is also effective when directly watching the live performance at a live venue instead of a TV receiver. That is, the present invention can be applied by acquiring the movement information of the user watching the live video together from the management server 15 and reflecting the movement information on the avatar of the user watching the live video together while watching the live video with the transmissive HMD.

Undoubtedly, even when the HMDs 11A and 11B are non-transmissive type, the display screen of the TV receiver 16 or the video of the live venue can be captured by the imaging unit 71 (camera) of the video processing device 7, and the captured video information can be displayed on the display unit 72 (display screen) of the video processing device 7. Therefore, it is needless to say that the present embodiment can be realized by acquiring the movement information of the users watching the live video together from the management server 15 and displaying the avatars of the users watching the live video together on the display screens of the non-transmissive HMDs 11A and 11B so as to overlap each other.

### Sixth Embodiment

In the first to fifth embodiments, the HMD, which is a portable video display device, is assumed. On the other hand, in the present embodiment, an example of being applied to a video display device other than the HMD will be described.

In the present embodiment, even in a portable video display device such as a smartphone or a tablet terminal, the direction of the video display device can be grasped. Therefore, the present invention can be applied by acquiring the movement information of the user watching the video together from the management server 15 and reflecting the movement information on the avatar of the user watching the video together.

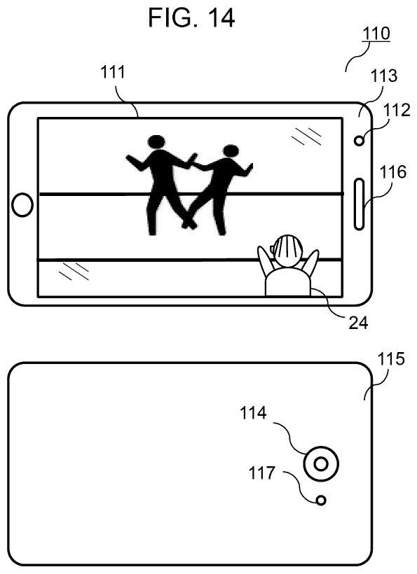

FIG. 14 is an external view of a smartphone in the present embodiment. In FIG. 14, a display screen 111 having a touch panel, a front camera (also referred to as an in-camera) 112 for taking a selfie, a speaker, and a microphone 116 are provided on a smartphone front 113 of a smartphone 110. In addition, a rear camera (also referred to as an out-camera or simply a camera) 114 and a microphone 117 are provided on a back surface 115 of the smartphone.

In the smartphone 110, various sensors are mounted as in the HMD even though the various sensors cannot be seen from the outside, so that it is possible to detect the direction of the smartphone 110 itself. In addition, on the display screen 111 of the smartphone 110, a screen equivalent to the display screen 22 of the HMD 11A worn by the first user 10A described in the first embodiment is displayed.

The movement information and audio information of the user watching the video together, which are provided from the management server 15, are reflected and displayed on the avatar 24 of the user watching the video together. However, since it is somewhat difficult for the smartphone 110 to grasp its own movement state, it is restricted to transmit the movement information to other users watching the video together. However, since it is possible to enjoy a live concert together with other users in rhythm synchronization using an existing smartphone, there is an effect of improving the realistic feeling.

In addition, a moving image (movement information and audio information) of the user himself or herself watching the video can be captured by the front camera 112 for taking a selfie of the smartphone 110, and the video information including the audio information can be transmitted as movement information to the management server 15 through the wireless router 12 and the network 13. As a result, since the video information including the audio information is provided from the management server 15, the video information including the audio information can be reflected and displayed on the avatar of the user watching the video together.

In the present embodiment, a smartphone is taken as an example of a portable video display device, but the present invention can be realized if there is an equivalent or similar hardware configuration or software configuration. For example, the present invention can also be applied to a notebook PC or a tablet PC.

In addition, it is needless to say that the present invention can also be applied to a desktop PC that is fixedly used on the premise that the direction of the HMD does not change (front only).

In addition, when a TV tuner is built in or connected to a smartphone, the present embodiment can also be applied to the fifth embodiment described above. That is, by displaying the TV screen on the display screen 111 of the smartphone 110 and capturing the moving image (movement information and audio information) of the user himself or herself watching the video with the front camera 112 for taking a selfie of the smartphone 110, the video information including the audio information can be transmitted as movement information to the management server 15 through the wireless router 12 and the network 13. As a result, since the video information including the audio information is provided from the management server 15, the video information including the audio information can be reflected and displayed on the avatar of the user watching the video together. Undoubtedly, by providing a built-in or external camera function in the TV receiver 16 and capturing the moving image (movement information and audio information) of the user himself or herself watching the TV receiver 16, the video information including the audio information may be used as movement information.

### Seventh Embodiment

In the embodiment described above, it is assumed that the movement information of another user is used and displayed so that this is reflected on the avatar that is the alter ego of another user. On the other hand, in the present embodiment, an example in which the movement information of another user is not used will be described.

When the movement information of another user is acquired, a delay time occurs in order to reflect the movement information on the avatar that is the alter ego of another user. On the other hand, when the avatars of the users watching the video together are displayed in complete synchronization with the rhythm, the realistic feeling is improved. Therefore, it is important to be in complete synchronization with the rhythm, even if the movement is different from the movement of the user watching the video together.

Therefore, in the present embodiment, the movement information itself of the host user completely synchronized with the rhythm is reflected and displayed on the avatar that is the alter ego of another user.

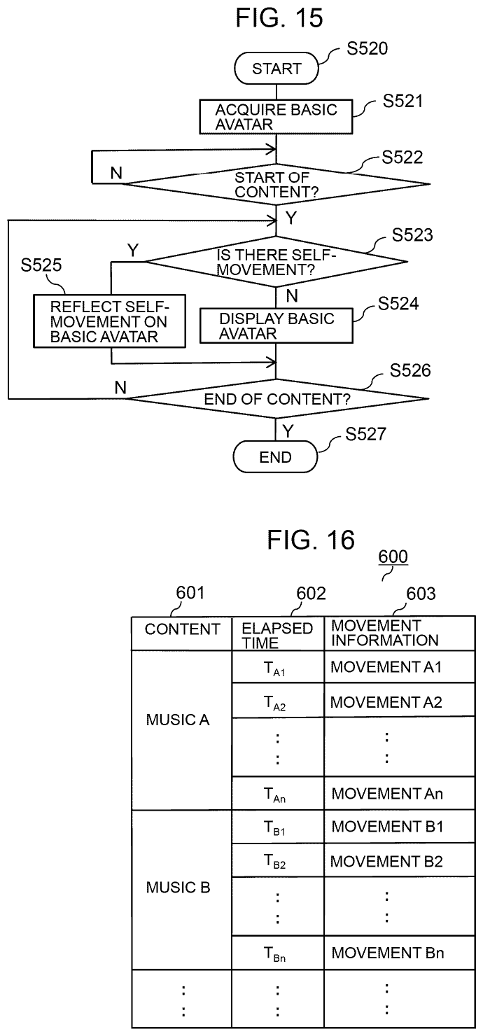

FIG. 15 is a flowchart showing self-movement reflection processing procedure in the present embodiment. In FIG. 15, when the self-movement reflection processing is started (S520), the basic avatar (explained in the first embodiment) of the user watching the video together is acquired from the management server 15 (S521).

Then, in the processing of S522, the start of the content is awaited. If it is determined that the content has started in the processing of S522, it is determined whether or not there is a self-movement (S523). If there is no self-movement in the processing of S523, the basic avatar of the user watching the video together is displayed (S524). If there is a self-movement in the processing of S523, the avatar of the user watching the video together is displayed so that the self-movement is reflected on the basic avatar of the user watching the video together (S525).

Then, it is determined whether or not the content has ended (S526). If the content has not ended in the processing of S526, the process returns to S523 to prepare for the next self-movement. If the content has ended in the processing of S526, the self-movement reflection processing ends (S527).

Thus, since the movement information itself of the host user is reflected and displayed on the avatar of the user watching the video together, the movement information can be displayed in complete synchronization with the rhythm.

In addition, it is possible to imagine the movement of other users in advance, reflect the imaginary movement information of the other users in the avatars that are alter egos of the other users, and display the movement information at the beginning of each rhythm section in complete synchronization with the rhythm. Specifically, this means that the moving avatar in the avatar rhythmic movement (S414) in the flowchart of the avatar display processing of FIG. 8 described in the first embodiment is displayed as the avatar of the movement imagined in advance.

By these methods, it is possible for the host user to be completely synchronized with the rhythm in a timely manner and to obtain a sense of unity with other users. Undoubtedly, it is needless to say that these methods can be used in combination with the embodiments described above.

### Eighth Embodiment

In the embodiments described above, it is assumed that the movement information of the avatar s acquired from the management server 15 or the like each time. On the other hand, in the present embodiment, an example of acquiring the movement information of the avatar in advance will be described.

In a live concert, a movement suitable for the music of the live concert is desired. In the present embodiment, a library server that provides a movement suitable for the music as a library in advance through the network 13 is provided.

FIG. 16 is an example of a table of libraries registered in a library server in the present embodiment. In FIG. 16, a library table 600 includes a content column 601 having identification information indicating a music name, an elapsed time column 602 indicating an elapsed time from a music, and a movement information column 603 indicating movement information of a movement suitable for the music of a live concert.

It is possible to provide all the pieces of movement information up to the start time or the end time for the music as a library. In the present embodiment, however, the library storage capacity can be reduced by registering only the time point (elapsed time) of the movement.

By acquiring the elapsed time and the movement information from the library server in advance, the user can display the movement of the avatar suitable for the music of the live concert. Therefore, the user can enjoy the live concert with a more realistic feeling.

In the case of video distribution of a live concert or the like, the movement of the audience in the live concert can be grasped in advance, and the movement of the audience can be patterned and provided as movement information. As a result, it is possible to enjoy a more realistic live concert.

In addition, due to the library server, it is also possible to arbitrarily extract the movement information of the movement suitable for the music from the movement information column 603 of the library table 600, and it is possible to arbitrarily display the avatar synchronized with the rhythm according to the user's preference.

In addition, the present embodiment can also be applied to the content that is not synchronized with the rhythm. For example, the present embodiment can be applied to laughter in comedy (comic storytelling or comic dialogue), cheering for sports, and shouts in Kabuki.

Undoubtedly, it is needless to say that the distribution server 14 or the management server 15 described above can be made to have the function of the library server.

While the embodiments of the present invention have been described above, the present invention is not limited to the embodiments described above, and includes various modification examples. For example, in the above embodiments, the components have been described in detail for easy understanding of the present invention. However, the present invention is not necessarily limited to having all the components described above. In addition, some of the components in one embodiment can be replaced with the components in another embodiment, and the components in another embodiment can be added to the components in one embodiment. In addition, for some of the components in each embodiment, addition, removal, and replacement of other components are possible. In addition, each of the above-described components, functions, and processing units may be realized by hardware, for example, by designing some or all of these with an integrated circuit or the like.

### REFERENCE SIGNS LIST

1, 11A, 11BHMD
2 Main control device
4 Storage device
5 Sensor device
6 Communication processing device
7 Video processing device
8 Audio processing device
9 Operation input device
10A, 10B User
13 Network
14 Distribution server
15 Management server
22 Display screen
24 Avatar
30 Control unit
31 Various sensor information acquisition unit
32 Communication processing unit
33 Others movement information storage unit
34 Avatar information storage unit
35 Avatar generation processing unit
36 Avatar display processing unit
37 Rhythm detection processing unit
38 Self-movement information storage unit
S200 Preparation processing
S300 Live content processing
S400 Avatar display processing

1. A head-mounted display for displaying a video of a content distributed via a network, the head-mounted display comprising:
a communication unit connected to the network;
a display configured to display the video of the distributed content received by the communication unit; and
a processing circuit,
wherein the communication unit is configured to receive avatar information and movement information of another person viewing simultaneously the video of the distributed content with a user of the head-mounted display, and
wherein the processing circuit configured to:
detect whether the movement information received by the communication unit includes a first movement information indicating a continuous movement of the another person,
in response to detecting that the first movement information is included in the movement information, generate rhythmic movement information synchronized with rhythm information included in the distributed content, and generate an avatar of the another person from the avatar information received by the communication unit, by adding a second movement information that is the movement information other than the first movement information, and
control the display to display the generated avatar of the another person overlapping the video of the distributed content.

2. The head-mounted display according claim 1, wherein the rhythm information is information indicating a rhythm of a music associated with the video of the distributed content.

3. The head-mounted display according claim 1, further comprising a sensor configured to detect a movement of the head-mounted display,
wherein the processing circuit configured to generate an avatar of the user of the head-mounted display according to the movement detected by the sensor, and control the display to display the avatar of the another person and the avatar of the user overlapping the video of the distributed content.

4. The head-mounted display according claim 1, further comprising a camera configured to take a picture of the user of the head-mounted display,
wherein the processing circuit configured to generate movement information of the user based on the picture of the user taken by the camera, generate an avatar of the user in consideration of the generate movement information, and control the display to display the avatar of the another person and the avatar of the user overlapping the video of the distributed content.

5. A head-mounted display for displaying a video of a content distributed via a network, the head-mounted display comprising:
a communication interface connected to the network;
a display configured to display the video of the distributed content received by the communication interface; and
a processing circuit,
wherein the communication interface is configured to receive avatar information and movement information of another person viewing simultaneously the video of the distributed content with a user of the head-mounted display, and
wherein the processing circuit configured to:
detect whether the movement information received by the communication interface includes a first movement information indicating a continuous movement of the another person,
in response to detecting that the first movement information is included in the movement information, generate rhythmic information movement synchronized with rhythm information included in the distributed content, and generate an avatar of the another person from the avatar information received by the communication interface, by adding a second movement information that is the movement information other than the first movement information, and
control the display to display the generated avatar of the another person overlapping the video of the distributed content.

6. The head-mounted display according claim 5, wherein the rhythm information is information indicating a rhythm of a music associated with the video of the distributed content.

7. The head-mounted display according claim 5, further comprising a sensor configured to detect a movement of the head-mounted display,
wherein the processing circuit configured to generate an avatar of the user of the head-mounted display according to the movement detected by the sensor, and control the display to display the avatar of the another person and the avatar of the user overlapping the video of the distributed content.

8. The head-mounted display according claim 5, further comprising a camera configured to take a picture of the user of the head-mounted display,
wherein the processing circuit configured to generate movement information of the user based on the picture of the user taken by the camera, generate an avatar of the user in consideration of the generate movement information, and control the display to display the avatar of the another person and the avatar of the user overlapping the video of the distributed content.

9. A display control method of a head-mounted display for displaying a video of a content distributed via a network, comprising:
receiving avatar information and movement information of another person viewing simultaneously the video of the distributed content with a user of the head-mounted display;
detecting whether the received movement information includes a first movement information indicating a continuous movement of the another person;
in response to detecting that the first movement information is included in the received movement information, generating rhythmic movement information synchronized with rhythm information included in the distributed content;
generating an avatar of the another person from the received avatar information by adding a second movement information that is the movement information other than the first movement information; and
displaying the generated avatar of the another person overlapping the video of the distributed content.

10. The display control method according claim 9, wherein the rhythm information is information indicating a rhythm of a music associated with the video of the distributed content.

11. The display control method according claim 9, further comprising:
detecting a movement of the head-mounted display;
generating an avatar of the user of the head-mounted display according to the detected movement; and
displaying the avatar of the another person and the avatar of the user overlapping the video of the distributed content.

12. The display control method according claim 9, further comprising:
capturing a picture of the user of the head-mounted display;
generating movement information of the user based on the captured picture of the user;
generate an avatar of the user in consideration of the generate movement information; and
displaying the avatar of the another person and the avatar of the user overlapping the video of the distributed content.
